(19) United States
(12) Patent Application Publication
(10) Pub. No.: US 2024/0019314 A1
(43) Pub. Date: Jan. 18, 2024

(54) PRECISE TEMPERATURE MEASUREMENT STRUCTURE

(71) Applicant: SHANGHAI D&G MACHINERY EQUIPMENT CO.,LTD, Shanghai (CN)

(72) Inventor: Xiaofeng Qin, Shanghai (CN)

(21) Appl. No.: 18/076,842

(22) Filed: Dec. 7, 2022

(30) Foreign Application Priority Data
Jul. 15, 2022 (CN) 202210833134.6

(51) Int. Cl. G01K 1/16; G01K 1/14

(52) U.S. Cl. CPC G01K 1/16; G01K 1/14

(57) ABSTRACT

The present invention discloses a precise temperature measurement structure, which comprises a measured metal body, a temperature measurement probe and a contact tube. The measured metal body is provided with a hole for temperature measurement, and the contact tube is tightly attached to the inside of the hole for temperature measurement on the measured metal body. The gap between the outside of the contact tube and the inside wall of the hole for temperature measurement on the measured metal body is controlled to be less than 0.05 mm. The temperature measurement probe is tightly attached to the inside of the contact tube. The gap between the inside wall of the contact tube and the outside of the temperature measurement probe is controlled to be less than 0.2 mm. The material of the contact tube is made of silver. The precise temperature measurement structure uses soft, stable and high-purity silver as a medium to measure the temperature, and the inner side wall of the hole used for measuring the temperature of the measured metal body finally conducts the temperature accurately to the outer circle of the temperature measurement probe through the silver contact tube. The silver contact tube accurately transmits the temperature, the structure is stable for a long time, and its use is environmentally friendly.

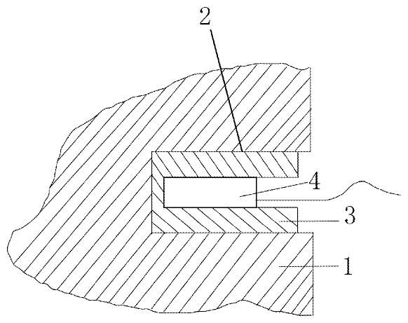

### TECHNICAL FIELD

The present invention relates to the technical field of industrial temperature measurement structures, and in particular to a precise temperature measurement structure for measuring the temperature of metal bodies (especially various steel materials).

### BACKGROUND ART

Metal heating and temperature measurement and control are widely applied in all walks of life. To control the temperature, it is necessary to measure the temperature, and the temperature measurement probes are used. Most of the temperature measurement probes are in a cylindrical shape (especially PT100). Traditionally, the temperature measurement probes are directly contacted with the measured metal. The most widely applied metal in the manufacturing industry is steel. To measure the temperature of the metal body (especially the steel with various hardness after heat treatment), most of the holes are punched on the metal body (especially the steel). The traditional temperature measurement method is to directly put the temperature measurement probe into the hole on the metal (especially the steel) with the temperature being measured.

As the hole will deform a little after the whole processing and/or various heating treatments, the gap between the hole and the temperature measurement probe cannot be very small, and the temperature measurement probe and the hole wall metal cannot be in close contact or get close to close contact (otherwise, the temperature measurement probe cannot be inserted), which will cause an temperature measurement error. Therefore, a special grease (dry or not) is often used for compensation. However, this kind of compensation is limited, and it will be weakened with time because it will volatilize less when it is used.

There are still many methods to solve this problem. It will be inconvenient without a hole punched, or the temperature measurement probe cannot be replaced after being installed, it is more fragile and not permanent and reliable.

The present invention completely abandons the original structure, designing a temperature measurement structure using soft, stable and high-purity silver as a medium.

### SUMMARY OF THE INVENTION

In order to solve the problems existing in the above background art, the present invention provides a precise temperature measurement structure, which uses soft, stable and high-purity silver as a medium for temperature measurement. The inner side wall of the hole used for temperature measurement on the measured metal body finally conducts the temperature accurately to the outer circle of the temperature measurement probe through a silver contact tube, which accurately transmits the temperature, the structure is stable for a long time, and its use is environmentally friendly.

In order to achieve the above purpose, the present invention adopts the following technical solutions:

The present invention provides a precise temperature measurement structure, which comprises a measured metal body, a temperature measurement probe and a contact tube (in a tubular shape with two empty ends or one empty end);

The measured metal body is provided with a hole for temperature measurement, and the contact tube is tightly attached to the inside of the hole for temperature measurement. The gap between the outside of the contact tube and the inside wall of the hole for temperature measurement on the measured metal body is controlled to be less than 0.05 mm. The temperature measurement probe is tightly attached to the inside of the contact tube. The gap between the inside wall of the contact tube and the outside of the temperature measurement probe is controlled to be less than 0.2 mm. The material of the contact tube is made of silver.

In the above technical solutions, the gap between the silver contact tube and the hole used for temperature measurement on the measured metal body can be controlled to be less than 0.05 mm, and both of them can be completely bonded without a gap.

The gap between the silver contact tube and the internal temperature measurement probe is controlled to be less than 0.2 mm.

The thermal conductivity (K) of silver is 429, which is superior to that of gold (317) and copper (401). The price of silver is only about 1% of that of gold. Silver is much softer than copper and has a stable performance, so the contact tube is made of silver. The practical studies and tests show that the higher the purity of silver, the better the use effect.

As a medium, the silver contact tube is soft, stable and easy to process, forming a hole-type temperature measurement (probe) structure with good permanent contact, close contact, accurate temperature measurement and long-term stability.

The further improvement is that the contact tube has a hollow structure with one end opening, and the contact tube can also have a hollow structure with two ends opening.

The final shape of the silver contact tube is tubular. When it is installed and used, the hollow contact tube can be directly installed into the hole for temperature measurement on the measured metal body. It is also possible to adopt a solid or tubular shape with a margin. After the contact tube is tamped and contacted with the hole for temperature measurement on the measured metal body, a high-precision hole is formed. Because of the characteristics of silver, it is very easy to make a high-precision hole.

The further improvement is that the temperature measurement probe is in a cylindrical shape. As the cylindrical temperature measurement probe is easy to have a gap when being installed on the measured metal body, the structure in this application can be perfectly applied to the installation of the cylindrical temperature measurement probe.

After practical studies and tests, the temperature control of the metal (quenched alloy steel) of our vulkameter, the temperature control of the metal (quenched alloy steel) of the Mooney's viscosimeter and the temperature control of the metal (stainless steel) of the rapid plasticity meter are all implemented by the structures in this application, which prove that they have good practical effects—high precision and stable temperature measurement. Also, the temperature control of computer software is correspondingly stable, and the actual temperature control can really and easily reach 0.01. This structure can also be used in other fields with high requirements for temperature control.

Compared with the prior art, the present invention has the following beneficial effects:

The present invention completely abandons the previous single punching structure pattern, and adopts soft, stable and high-purity silver as a medium for temperature measurement. The outer side of the silver contact tube is tightly attached to the inner side wall of the hole used for temperature measurement on the measured metal body, the outer side of the temperature measurement probe is tightly attached to the inner side wall of the silver contact tube. The inner side wall of the hole used for measuring the temperature of the measured metal body finally conducts the temperature accurately to the outer circle of the temperature measurement probe through the silver contact tube. The silver contact tube accurately transmits the temperature. The whole temperature measurement is more accurate, the temperature control is stable, and permanent precision contact temperature measurement and control can be achieved. It can be widely applied in many places involving metal temperature control, and its significance is very extensive.

### DESCRIPTION OF FIGURES

The present invention will be further explained with reference to the figures and specific embodiments.

The sole FIGURE is a structural schematic diagram of a precise temperature measurement structure in the present invention;

In particular, the specific reference marks are: the measured metal body 1, the hole 2 for temperature measurement, the contact tube 3, and the temperature measurement probe 4.

### SPECIFIC IMPLEMENTATIONS

The embodiment of the present invention discloses a precise temperature measurement structure, which comprises a measured metal body 1, a temperature measurement probe 4 and a contact tube 3;

The measured metal body 1 is provided with a hole 2 for temperature measurement, and the contact tube 3 is tightly attached to the inside of the hole 2 for temperature measurement on the measured metal body. The gap between the outside of the contact tube 3 and the inside wall of the hole 2 for temperature measurement on the measured metal body 1 is controlled to be less than 0.05 mm. The temperature measurement probe 4 is tightly attached to the inside of the contact tube 3. The gap between the inside wall of the contact tube 3 and the outside of the temperature measurement probe 4 is controlled to be less than 0.2 mm. The material of the contact tube is made of silver.

In the above technical solutions, the gap between the silver contact tube 3 and the hole 2 for temperature measurement on the measured metal body 1 can be controlled to be less than 0.05 mm, and both of them can be completely bonded without a gap.

The gap between the silver contact tube 3 and the internal temperature measurement probe 4 is controlled to be less than 0.2 mm.

The thermal conductivity (K) of silver is 429, which is superior to that of gold (317) and copper (401). The price of silver is only about 1% of that of gold. Silver is much softer than copper and has a stable performance, so the silver contact tube 3. The practical studies and tests show that the higher the purity of silver, the better the use effect.

As a medium, the silver contact tube 3 is soft, stable and easy to process, forming a hole-type temperature measurement (probe) structure with good permanent contact, close contact, accurate temperature measurement and long-term stability.

Specifically, the contact tube 3 has a hollow structure with one end opening, and the contact tube 3 can also have a hollow structure with two ends opening.

The final shape of the silver contact tube 3 is tubular. When it is installed and used, the hollow contact tube 3 can be directly installed into the hole 2 for temperature measurement on the measured metal body 1. It is also possible to adopt a solid or tubular shape with a margin. After the contact tube 3 is tamped and contacted with the hole 2 for temperature measurement on the measured metal body 1, a high-precision hole is formed. Because of the characteristics of silver, it is very easy to make a high-precision hole.

Specifically, the temperature measurement probe 4 is in a cylindrical shape. As the cylindrical temperature measurement probe 4 is easy to have a gap when being installed on the measured metal body 1, the structure in this application can be perfectly applied to the installation of the cylindrical temperature measurement probe 4.

Specifically, the measured metal body 1 is made of steel, alloy steel or stainless steel.

The thicker the wall thickness of the contact tube 3, the higher the cost. The thinner the wall thickness of the contact tube 3, and the more difficult it is to drill holes. After considering the above factors, the wall thickness of the contact tube 3 is preferably controlled to be to 0.2-2 mm. After practical studies and tests, the temperature control of the metal (quenched alloy steel) of our vulkameter, the temperature control of the metal (quenched alloy steel) of the Mooney's viscosimeter and the temperature control of the metal (stainless steel) of the rapid plasticity meter are implemented by the structures in this application, which prove that they have good practical effects—high precision and stable temperature measurement. Also, the temperature control of computer software is correspondingly stable, and the actual temperature control can really and easily reach 0.01. This structure can also be used in other fields with high requirements for temperature control.

When the precise temperature measurement structure is used to control the temperature control of vulkameter and after half a year, the temperature of the material inside the instrument is constantly controlled at 190° C., and the temperature measured by the temperature measurement probe is between 189.90° C. and 190.10° C.

When the existing structure is adopted, a hole for measuring temperature is directly opened in the metal body to be measured, and then the temperature measurement probe is directly installed in the hole for measuring temperature. The temperature of the material inside the instrument is constantly controlled at 190° C., and the temperature after testing by the temperature measurement probe is from 189.90° C. to 190.10° C. With the extension of time, the temperature measurement test temperature gradually changes to 190.20° C.-190.40° C. in the first month. The measured temperature gradually changes from 190.60° C. to 190.80° C. in the third month. The measured temperature gradually changes from 191.00° C. to 191.20° C. in the sixth month. Due to the excessive difference between the measured temperature value and the actual temperature value, the temperature measurement probe should be maintained.

To sum up, the present invention completely abandons the previous single punching structure, and adopts soft, stable and high-purity silver as a medium for temperature measurement. The outer side of the silver contact tube 3 is tightly attached to the inner side wall of the hole 2 used for temperature measurement on the measured metal body 1, and the outer side of the temperature measurement probe 4 is tightly attached to the inner side wall of the silver contact tube 3. The inner side wall of the hole 2 for the temperature of the measured metal body 1 finally conducts the temperature accurately to the outer circle of the temperature measurement probe 4 through the silver contact tube 3. The silver contact tube accurately transmits the temperature. The whole temperature measurement is more accurate, the temperature control is stable, and permanent precision contact temperature measurement and control can be achieved. It can be widely applied in many places involving metal temperature control, and its significance is very extensive.

The above specific examples are used to illustrate the present invention, which is only used to help understand the present invention but not to limit the present invention. For those skilled in the technical field of the present invention and according to the idea of the present invention, some simple deduction, modification or substitution can be made.

1. A precise temperature measurement structure, comprising a measured metal body, a temperature measurement probe and a contact tube;
wherein, the measured metal body is provided with a hole for temperature measurement, and the contact tube is tightly attached to the inside of the hole for temperature measurement; the gap between the outside of the contact tube and the inside wall of the hole for temperature measurement on the measured metal body is controlled to be less than 0.05 mm; the temperature measurement probe is tightly attached to the inside of the contact tube; the gap between the inside wall of the contact tube and the outside of the temperature measurement probe is controlled to be less than 0.2 mm; the material of the contact tube is made of silver.
